(19) United States
(12) Patent Application Publication
(10) Pub. No.: US 2024/0430945 A1
(43) Pub. Date: Dec. 26, 2024

(54) METHOD OF AND APPARATUS OF POWER CONTROL FOR CANDIDATE CELL PRACH TRANSMISSION IN WIRELESS COMMUNICATION SYSTEM

(71) Applicant: Samsung Electronics Co., Ltd., Suwon-si (KR)

(72) Inventors: Kyoungmin PARK, Suwon-si (KR); Hyewon YANG, Suwon-si (KR); Jaewon LEE, Suwon-si (KR); Junyung YI, Suwon-si (KR)

(21) Appl. No.: 18/738,565

(22) Filed: Jun. 10, 2024

(30) Foreign Application Priority Data
Jun. 22, 2023 (KR) 10-2023-0080274

(51) Int. Cl. H04W 74/0833; H04B 17/318; H04W 74/08; H04W 76/20

(52) U.S. Cl. CPC H04W 74/0833; H04B 17/318; H04W 74/0891; H04W 76/20

(57) ABSTRACT

The disclosure relates to a 5th generation (5G) or 6th generation (6G) communication system for supporting higher data rates. A method performed by a terminal in a wireless communication system is provided. The method includes receiving, on a serving cell, information on a measurement for a pathloss associated with a physical random access channel (PRACH) transmission for non-serving cell, identifying a way of the measurement for the pathloss associated with the PRACH transmission, based on an indication of a cell specific measurement or a transmission configuration indication (TCI) specific measurement, or identifying the way of the measurement for the pathloss associated with the PRACH transmission, based on an indication of a layer 1 (L1) measurement or a layer 3 (L3) measurement, performing the measurement for the pathloss for a reference signal based on the identified way, and transmitting, on a candidate cell, the PRACH transmission based on the pathloss.

### CROSS-REFERENCE TO RELATED APPLICATION(S)

This application is based on and claims priority under 35 U.S.C. § 119 (a) of a Korean patent application number 10-2023-0080274, filed on Jun. 22, 2023, in the Korean Intellectual Property Office, the disclosure of which is incorporated by reference herein in its entirety.

### BACKGROUND

### 1. Field

The disclosure relates to a method of controlling power for physical random access channel (PRACH) transmissions targeting candidate cells and an apparatus thereof in a wireless communication system. More particularly, the disclosure relates to a method and an apparatus for measuring and reporting beam information and multi-cell information, and performing a handover in a wireless communication system.

### 2. Description of Related Art

5th generation (5G) mobile communication technologies define broad frequency bands such that high transmission rates and new services are possible, and can be implemented not only in “Sub 6 GHz” bands, such as 3.5 GHZ, but also in “Above 6 GHz” bands referred to as millimeter wave (mmWave) including 28 GHz and 39 GHz. In addition, it has been considered to implement 6th generation (6G) mobile communication technologies (referred to as beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

With the advance of wireless communication systems as described above, various services can be provided, and accordingly there is a need for ways to effectively provide these services.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a low-latency mobility support technique for performing a handover based on layer 1 (L1)/layer 2 (L2) measurements or L1/L2 signaling.

Another aspect of the disclosure is to provide a method related to a radio access network 1 (RAN1) signal used for L1 measurement before handover and handover command transmission.

Another aspect of the disclosure is to provide a method in which a terminal performs physical random access channel (PRACH) transmission targeting a candidate cell.

Additional aspects will be set forth in part in the description which follows and, in part, will be apparent from the description, or may be learned by practice of the presented embodiments.

In accordance with an aspect of the disclosure, a method performed by a terminal in a wireless communication system is provided. The method includes receiving, on a serving cell, information on a measurement for a pathloss associated with a physical random access channel (PRACH) transmission for non-serving cell, identifying a way of the measurement for the pathloss associated with the PRACH transmission, based on an indication of a cell specific measurement or a transmission configuration indication (TCI) specific measurement, or identifying the way of the measurement for the pathloss associated with the PRACH transmission, based on an indication of a layer 1 (L1) measurement or a layer 3 (L3) measurement, performing the measurement for the pathloss for a reference signal based on the identified way, and transmitting, on a candidate cell, the PRACH transmission based on the pathloss.

In accordance with another aspect of the disclosure, a method performed by a base station in a wireless communication system is provided. The method includes transmitting, to a terminal on a serving cell, information on a measurement for a pathloss associated with a physical random access channel (PRACH) transmission for a non-serving cell, and receiving, from the terminal, the PRACH transmission, wherein the PRACH transmission is based on the measurement for the pathloss for a reference signal, wherein a way of the measurement is indicated as a cell specific measurement or a transmission configuration indication (TCI) specific measurement, and wherein the way of the measurement is indicated as a layer 1 (L1) measurement or a layer 3 (L3) measurement.

In accordance with another aspect of the disclosure, a terminal is provided. The terminal includes a transceiver, and a controller coupled with the transceiver and configured to receive, on a serving cell, information on a measurement for a pathloss associated with a physical random access channel (PRACH) transmission for non-serving cell, identify a way of the measurement for the pathloss associated with the PRACH transmission, based on an indication of a cell specific measurement or a transmission configuration indication (TCI) specific measurement, or identify the way of the measurement for the pathloss associated with the PRACH transmission, based on an indication of a layer 1 (L1) measurement or a layer 3 (L3) measurement, perform the measurement for the pathloss for a reference signal based on the identified way, and transmit, on a candidate cell, the PRACH transmission based on the pathloss.

In accordance with another aspect of the disclosure, a base station is provided. The base station includes a transceiver and a controller coupled with the transceiver and configured to transmit, to a terminal on a serving cell, information on a measurement for a pathloss associated with a physical random access channel (PRACH) transmission for a non-serving cell, and receive, from the terminal, the PRACH transmission, wherein the PRACH transmission is based on the measurement for the pathloss for a reference signal, wherein a way of the measurement is indicated as a cell specific measurement or a transmission configuration indication (TCI) specific measurement, and wherein the way of the measurement is indicated as a layer 1 (L1) measurement or a layer 3 (L3) measurement.

According to an embodiment of the disclosure, when performing a handover to a candidate cell selected by a network, the terminal may complete a handover operation without a radio resource control (RRC) reconfiguration operation after a handover command. Due to the above effects, the terminal experiences a short interruption time and thus has two benefits, such as ensuring link stability and ensuring UE performance in an environment in which frequent handovers occur.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a handover procedure between standalone (SA) base stations as defined by third generation partnership project (3GPP) NR according to an embodiment of the disclosure;

FIG. 2 is a flow diagram illustrating a fast handover procedure according to an embodiment of the disclosure;

FIG. 3 is a flow diagram illustrating a Layer-1 reference signal received power (L1-RSRP)-based PRACH transmission procedure according to an embodiment of the disclosure;

FIG. 4 is a flow diagram illustrating a cell-specific Layer-3 (L3)-RSRP-based PRACH transmission procedure according to an embodiment of the disclosure;

FIG. 5 is a flow diagram illustrating a cell-specific L3-RSRP-based PRACH transmission procedure according to an embodiment of the disclosure;

FIG. 6 illustrates a configuration of a base station according to an embodiment of the disclosure; and

FIG. 7 illustrates a configuration of a UE according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing the embodiments of the disclosure, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, identical or corresponding elements are provided with identical reference numerals.

The advantages and features of the disclosure and ways to achieve them will be apparent by making reference to embodiments as described below in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined based on the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, long term evolution (LTE), LTE-advanced (LTE-A), or 5G systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more central processing units (CPUs) within a device or a security multimedia card. Furthermore, the “unit” in the embodiments may include one or more processors.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), Institute of Electrical and Electronics Engineers (IEEE) 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS, eNode B, or gNode B, and the downlink refers to a radio link via which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multiple-input multiple-output (MIMO) transmission technique are required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services, such as the Internet of things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of things. Since the Internet of things provides communication functions while being provided to various sensors and various devices, it must support a large number of UEs (e.g., 1,000,000 UEs/km2) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time, such as 10 to 15 years because it is difficult to frequently replace the battery of the UE.

Lastly, URLLC is a cellular-based mission-critical wireless communication service. For example, URLLC may be used for services, such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and also requires a packet error rate of 10-5 or less. Therefore, for the services supporting URLLC, a 5G system must provide a transmit time interval (TTI) shorter than those of other services, and also may require a design for assigning a large number of resources in a frequency band in order to secure reliability of a communication link.

The three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

In a cellular network system, each cell in a system is responsible for communication in a specific area, and when UE movement occurs, a connection is switched, through a conversion (i.e., handover) of a serving cell, to a cell responsible for communication in a new area to which the UE has moved. In the existing communication method, each cell may have different detailed configurations in a method of performing communication with a UE, and deliver the above details to the UE through system information broadcasting and RRC configuration. Therefore, a UE performing a handover first acquires system information by receiving broadcasting from a target cell, and thereafter receives the RRC configuration of the target cell while the handover is in progress to perform a RRC reconfiguration process.

In the existing communication method, the RRC reconfiguration process is disadvantageous of requiring a large signaling overhead and processing latency, and as a solution to this disadvantage, Rel-18 discusses L1/L2 signal-based handover or cell switching techniques. The corresponding discussion aims to prevent the RRC reconfiguration operation from being performed until cell switching or serving cell change is completed after a handover decision, and to reduce a handover interruption time through various other optimizations.

The disclosure provides L1/L2-based operations that should be performed before a handover decision to support L1/L2 signal-based handover, a method of performing the operations, control commands that should be delivered or performed simultaneously with handover commands, and the structure of full handover operations.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

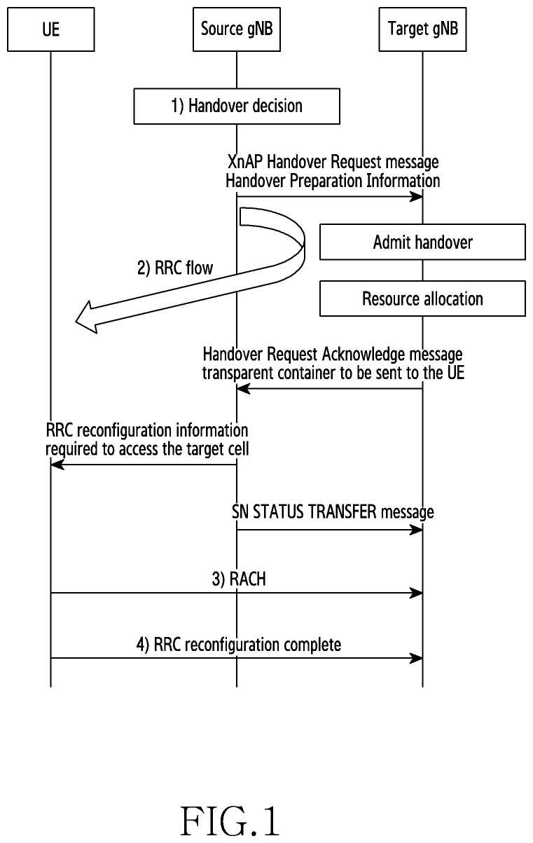

FIG. 1 illustrates a handover procedure between standalone (SA) base stations as defined by 3GPP NR according to an embodiment of the disclosure. Only for inter-next generation node B (gNB) handover shown in FIG. 1, the following cell is interpreted to have the same meaning as a base station or gNB.

Referring to FIG. 1, in operation 1), a source gNB (serving cell) may perform a handover decision. The serving cell receives a value of L3 measurement which a UE reports to each cell by using a cell-specific parameter, and compares the L3 measurements for multiple cells to determine whether to perform a handover and a target cell to be subject to handover.

When a handover is determined, the serving cell may notify the target cell of the same. For example, the serving cell may transmit an XnAP Handover Request message and Handover Preparation Information to the target cell.

The target cell determines whether to admit handover, by considering traffic load of a cell, or the like. When the handover is admitted, the target cell performs resource allocation and delivers the Handover Request Acknowledge message and transparent container to be sent to the UE to the serving cell, as in operation 2, while simultaneously delivering information about radio resources and other configurations (e.g., RRC reconfiguration information) that the UE should use to connect to the target cell to the UE which will perform a handover via RRC flow. At this time, the target cell delivers the RRC reconfiguration information to the serving cell, instead of directly delivering the RRC reconfiguration information to the UE which will perform a handover, and then causes the serving cell to deliver the same through a wireless link used for communication with the corresponding UE.

The UE that has received the RRC reconfiguration information attempts to access a target cell through a random access channel (RACH) process (operation 3) and, if the access is successful, modifies all relevant configurations to those required to communicate with the target cell, through RRC reconfiguration (operation 4). The UE disconnects from the existing serving cell and simultaneously establishes a connection to the target cell being considered as a new serving cell.

As shown in FIG. 1, the existing handover procedure is largely configured by the following four operations.
1) Operation in which a serving cell decides handover based on L3 measurement
2) Operation in which a target cell approves the start of a handover procedure and transmits RRC default configurations to a UE.
3) Operation in which the UE attempts to access the target cell via RACH
4) Operation in which the UE reconfigures a radio link configuration to match the target cell, terminates a connection with the existing serving cell, and selects the target cell as a new serving cell.

After the handover decision of operation 1), the three operations of 2) to 4) should be performed sequentially, resulting in a latency, an interruption time, a signaling overhead, or the like, thereby.

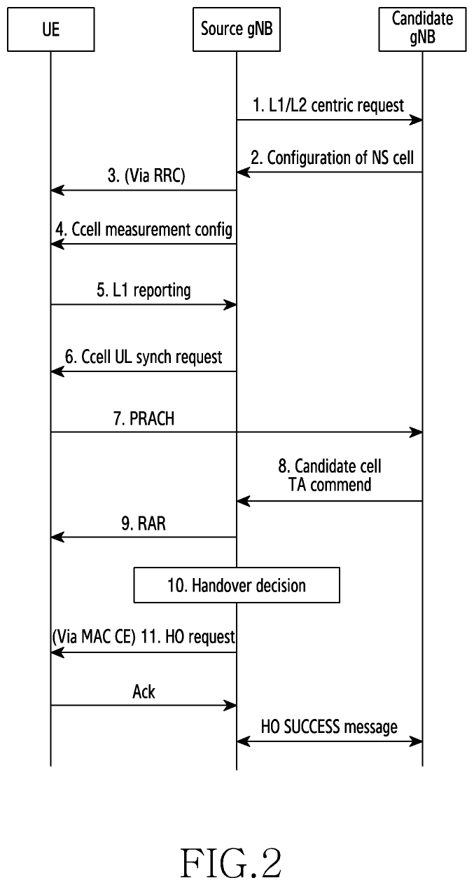

FIG. 2 is a flow diagram illustrating a fast handover procedure according to an embodiment of the disclosure. Hereinafter, a serving cell may be interpreted as a serving base station or a source gNB, and a candidate cell may be interpreted as a candidate base station or a candidate gNB.
1. In operation 1, the serving cell may select a candidate cell to be subject to fast handover and notify the candidate cell of the same. For each UE, the serving cell may select a different candidate cell, and for each UE, the serving cell may select one or multiple candidate cells. For example, the serving cell may transmit an L1/L2 centric request to a candidate cell.
2. In operation 2, the candidate cell may deliver, to the serving cell, link configurations required for the fast handover of a UE or configuration information required for initial access, such as RRC configuration information. For example, the candidate cell may deliver configurations of non-serving (NS) cell to the serving cell.
The configuration information delivered by a candidate cell to the serving cell may include configurations for a RACH process, such as PRACH radio resource configurations and synchronization signal block (SSB) configurations related to a UE. The candidate cell may deliver, to the serving cell, the configurations for the RACH process, such as SSB configurations and PRACH radio resource configurations for the UE.
When delivering the configurations for the RACH process to the serving cell, the candidate cell may distinguish between information used for the general RACH process and information used for candidate cell synchronization (e.g., information for the RACH process performed to obtain candidate cell timing advance (TA) information) and deliver each information separately.
The configuration information for the RACH process used for fast handover may be different from the RACH process configuration information used when the candidate cell configures itself as the serving cell or the RACH process configuration information that the candidate cell delivers to a UE to be accessed when the candidate cell uses a handover method other than the fast handover method. For example, a PRACH radio resource used in fast handover may be different from a PRACH radio resource configured for a RACH process performed for other purposes.
3. In operation 3, the serving cell may deliver the configuration information, which has been received from the candidate cell, to a UE, for example, via a scheme, such as RRC configuration.
The configuration information delivered from the candidate cell, through the serving cell, to the UE may include a reference signal (RS) to be used for candidate cell discovery or a reference signal to be used for initial transmission to the candidate cell (e.g., initial synchronization to be used for PRACH transmission). For example, the configuration information may include information about an SSB and information about a radio resource to be used for PRACH transmission based on the corresponding SSB.
By delivering the information about the SSB and PRACH radio resource to the UE, the serving cell may notify the UE that the PRACH radio resource is a radio resource used for PRACH transmission targeting a candidate cell. This notification may be implemented in the form of notifying of separate information about PRACH radio resources, or may be implemented in the form of notifying of that PRACH radio resources are associated with a candidate cell SSB.
3-1. In case that the information received by the UE in operation 3 is information regarding multiple candidate cells, the UE may store the received information as separate information for each candidate cell. For example, the received information may be stored in the form of configuration information for a first candidate cell and configuration information for a second candidate cell.
4. In operation 4, the serving cell may deliver information about the link quality measurement for the candidate cell to the UE in the form of a measurement target (e.g., a reference signal (RS) resource, an RS resource set, or an RS resource group, or the like). For example, the serving cell may transmit candidate cell (Ccell) measurement config to the UE.
In operation 4, the candidate cell reference signal that the UE should measure may include only reference signals for some candidate cells configured in operation 3.
In operation 4, the candidate cell reference signal that the UE should measure may include SSBs of the corresponding candidate cell or part of the SSBs.
In operation 4, information about the candidate cell reference signal that the UE should measure may be delivered to the UE in the form of a transmission configuration index (TCI) state.
In operation 4, when the information about the candidate cell reference signal that the UE should measure is delivered to the UE in the form of a TCI state, the TCI state may further include operations of RRC configuration and medium access control (MAC) control element (CE) activation.
5. In operation 5, the serving cell may instruct the UE to measure and report the candidate cell link quality based on the delivered reference signal.
The instruction in operation 5 may be performed through periodic channel state information (CSI) reporting, or performed through semi-persistent or aperiodic reporting. Alternatively, in specific cases, the instruction in operation 5 may be performed through event triggered reporting in which reporting is performed.
When the instruction in operation 5 is performed through continuous reporting, such as periodic CSI reporting, with only initial configurations without separate reporting commands, operation 6 may be omitted.
The instruction in operation 5 may be a command for reporting other than measurement reporting for a channel, or may be a command of instructing to perform candidate cell measurement and search without reporting. For example, the serving cell may instruct the UE to perform a synchronization operation for the candidate cell.
For example, the above command may be a command in which the serving cell instructs the UE to perform a downlink synchronization for a specific candidate cell. In this case, the UE may be instructed to report the results of the downlink synchronization to the serving cell, or the UE may be instructed to perform only the synchronization operation without reporting.
As another example, the above command may be a command in which the serving cell instructs the UE to perform an uplink synchronization for a specific candidate cell. Upon receiving such a command, the UE may obtain uplink synchronization information for an instructed candidate cell, by using a difference in the downlink reception time between a reference signal used for downlink synchronization of a cell (e.g., a serving cell) in which uplink synchronization has been completed and a reference signal used for downlink synchronization of the instructed candidate cell.
According to various examples above, when the serving cell delivers a command to instruct the UE to perform a measurement, the serving cell may deliver information about the reference signal to be measured and the candidate cell to be measured in the form of a TCI state.
The TCI state may be in the form of a TCI state configuration, a TCI state update, a TCI state activation, or a TCI state indication.
5-1. The UE may report the measurement information received in operation 5 to the serving cell in operation 5-1.
For example, if the UE is instructed to measure and report link quality, the UE may deliver instant measurement information, such as good beam index, L1-RSRP, and L1-signal to interference noise ratio (SINR) to the serving cell (i.e., L1 reporting).
Alternatively, the UE may deliver information obtained by aggregating multiple measurement results based on a time domain, a spatial domain, etc. to the serving cell.
Alternatively, if the UE is instructed to perform synchronization, the UE may report to the serving cell whether synchronization has occurred, report to the serving cell the candidate cell TA value obtained through synchronization, or report to, the serving cell, information about the reference signal used for synchronization of the candidate cell.
When the UE performs synchronization based on the TCI state delivered in operation 4 and obtains a value of the candidate cell TA, the UE may associate the obtained TA value with the TCI state that caused the synchronization to occur and store same. Alternatively, when the UE selects a random TCI state to perform synchronization and obtains a value of the candidate cell TA, the UE may associate the obtained TA value with the corresponding random TCI state and store same. Alternatively, when there is no TCI state corresponding to the downlink reference signal used to obtain the TA value, the UE may report this to the serving cell so as to allow a new TCI state to be established, and may associate the obtained TA value with the new TCI state and store same.
Alternatively, when a command is unable to be performed, the UE may provide reporting of the command being unable to be performed to the serving cell.
5-2. At least some of operations 1 to 5 may be repeated depending on the result of the reporting of operation 5-1 or depending on whether a specific condition is satisfied.
For example, based on the result of the reporting of operation 5-1, the serving cell may perform the candidate cell selection again.
For example, link quality reporting for a candidate cell of the UE may continue until the next operation, i.e., PRACH transmission to a candidate cell is required.
6. In operation 6, the serving cell may instruct the UE to perform PRACH transmission to a specific candidate cell (Ccell) (i.e., Ccell UL synch request).
Based on the results of the measurement and reporting by the UE in operation 5-1, the serving cell may configure or instruct the UE to prepare to perform a fast handover for the specific candidate cell.
For example, the serving cell may instruct the UE to perform PRACH transmission targeting a candidate cell. The PRACH transmission may be performed to obtain TA information about the candidate cell, rather than for communication (or access control) with the candidate cell.
In operation 6, the serving cell may deliver, to the UE, information about a PRACH radio resource to be used for the PRACH transmission targeting the candidate cell. In the disclosure, the PRACH radio resource used for the PRACH transmission targeting the candidate cell is distinct from a PRACH radio resource that is commonly used for communication or access control. Therefore, upon reception of the PRACH through the corresponding PRACH radio resource, the candidate cell may recognize that the PRACH transmission is an operation for pre-acquiring a TA value of the candidate cell prior to handover.
7. In operation 7, the UE may perform the PRACH transmission by using the PRACH radio resource. The UE may perform a pathloss measurement depending on the type of UL transmission channel or the purpose of use thereof.
In order to perform the above PRACH transmission, the UE may receive information configured for controlling the PRACH transmission power from the serving cell.
For example, the UE may receive information configured for the reference signal used for pathloss measurement from the serving cell. The reference signal used for the pathloss measurement may be an SSB associated with a radio resource used for the PRACH transmission, or may be a reference signal other than the SSB (e.g., a reference signal transmitted by the serving cell).
Further, the UE may receive additional information configured for controlling the power of the PRACH transmission from the serving cell. For example, the UE may receive a power offset value configured to be used during the PRACH transmission.
In addition, the UE may measure a pathloss based on L1 measurement rather than an L3 filtered value when performing the above PRACH transmission power control. For example, the UE may measure an L1-RSRP value through the SSB associated with the PRACH transmission, and may perform the PRACH transmission power control by using the L1-RSRP value as the pathloss value.

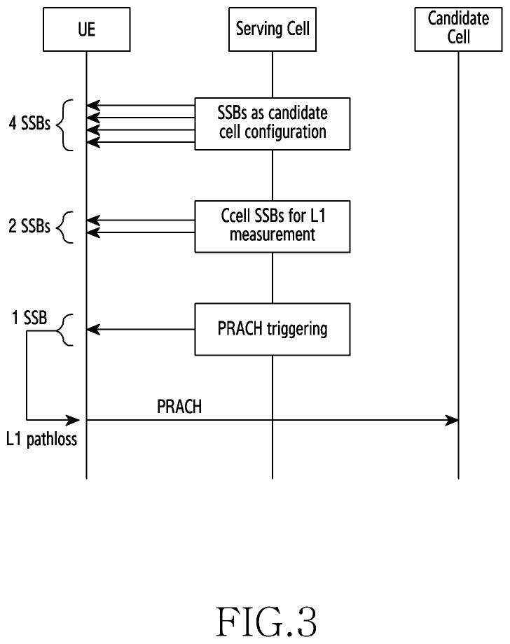

FIG. 3 is a flow diagram illustrating an L1-RSRP-based PRACH transmission procedure according to an embodiment of the disclosure.

Referring to FIG. 3, the pathloss may be obtained based on the L1-RSRP value measured through the SSB associated with PRACH triggering.
Alternatively, the UE may not perform a separate pathloss measurement when performing the above transmission power control for the PRACH transmission. For example, when the UE receives a candidate cell configured, the UE may perform an L3 mobility measurement on the candidate cell, and may use the value of the L3 mobility measurement as the pathloss value. According to an embodiment of the disclosure, the pathloss value measured based on the cell may be applied to power control.

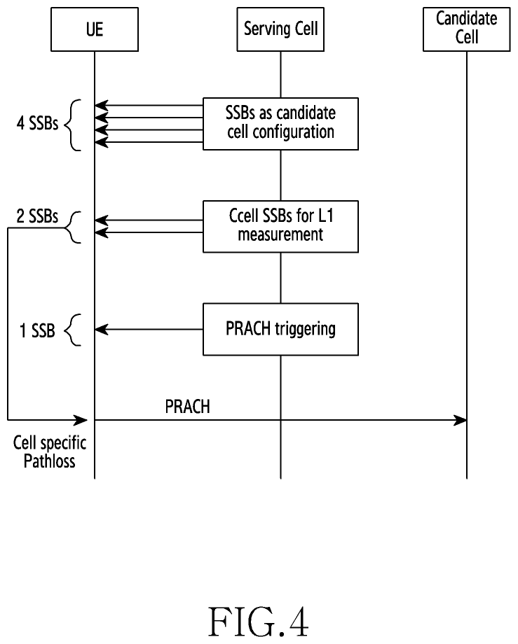

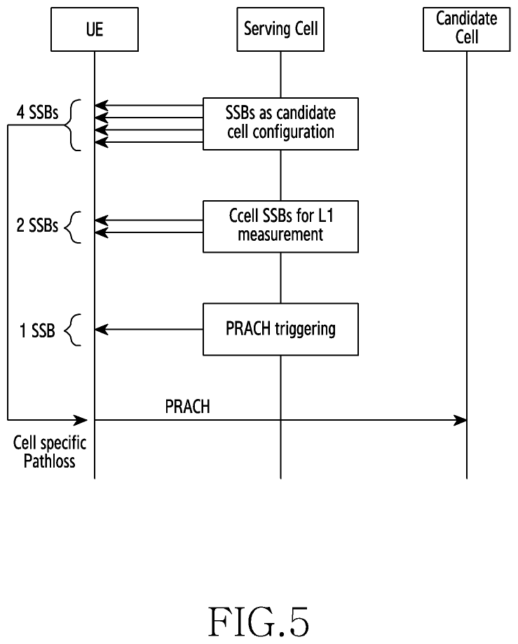

FIG. 4 is a flow diagram illustrating a cell-specific L3-RSRP-based PRACH transmission procedure according to an embodiment of the disclosure. FIG. 5 is a flow diagram illustrating a cell-specific L3-RSRP-based PRACH transmission procedure according to an embodiment of the disclosure.

Referring to FIG. 4, the cell-specific pathloss may be measured with respect to reference signals assigned to perform L1-measurement for candidate cells (or, measured based on reference signals assigned to perform L1-measurement for candidate cells).

Referring to FIG. 5, alternatively, the cell-specific pathloss may be measured based on all of the reference signals for mobility measurements (e.g., SSB or CSI-RS for mobility) configured for the candidate cell, or may be measured with respect to at least some of the reference signals having good reception performance among the above reference signals (or, measured based on some of the reference signals having good reception performance).
8. In operation 8, the candidate cell may deliver feedback on the PRACH transmission (or uplink transmission) to the serving cell. For example, the feedback information for the PRACH transmission may include TA information for a specific candidate cell of the UE, as measured by the PRACH transmission.
The candidate cell may recognize that the PRACH transmission of the UE in operation 7 is transmission for the fast handover of the disclosure, and may deliver the feedback information for the PRACH transmission to the serving cell rather than to the UE.
In order for the candidate cell to deliver feedback on the PRACH transmission to the serving cell, the candidate cell may identify the serving cell of the UE by the PRACH transmission received from the UE in operation 7 or by a notification from the serving cell received earlier.
For example, based on information about the radio resources used for the PRACH transmission that the UE has received from the serving cell in operation 6, the candidate cell may identify a serving cell that has transmitted the corresponding information to the UE.
Alternatively, in operation 7, the PRACH transmission may include information about the serving cell of the UE. The candidate cell may identify the serving cell of the UE based on the information about the serving cell included in the PRACH transmission.
Alternatively, in at least one operation of FIG. 2, the serving cell may notify the candidate cell of information regarding the selection of a candidate cell to be subject to handover, the handover decision, the PRACH transmission, or the like. The candidate cell may identify the serving cell of the UE based on the notification of the serving cell.

In operation 9, the serving cell may store the received feedback information or deliver the feedback information to the UE. The operation of the serving cell delivering the feedback information to the UE may be referred to as a random access response (RAR).
The serving cell may identify which UE's PRACH transmission the feedback is related to.
The serving cell may deliver the feedback information (e.g., TA information for a specific candidate cell of a specific UE measured by the PRACH transmission) to the corresponding UE, or may store the feedback information without forwarding the same to the UE when the serving cell determines that the use or application of the feedback information is not required.

In operation 10, the serving cell may determine whether to perform a fast handover, and designate a target cell for handover.
The serving cell may determine whether to perform a fast handover to the corresponding candidate cell for the UE through operations 1 to 11.
11. The serving cell may instruct the UE to perform a fast handover.
When the decision to perform a fast handover is made, a base station may provide the UE with a notification based on the decision to perform a fast handover. For example, the serving cell may transmit a handover request to the UE via a MAC CE.
The notification may include information about a channel on which transmission by the candidate cell is performed and information required to receive the RS.
For example, the notification may include information about a TCI state that the UE needs to apply in order to receive the transmission from the candidate cell.

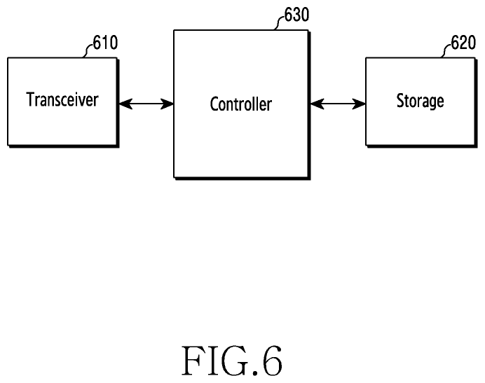

FIG. 6 is a block diagram illustrating an example of a configuration of a base station according to an embodiment of the disclosure.

Referring to FIG. 6, a base station of the disclosure may include a controller (a control unit) 630, a transceiver 610, and storage (memory) 620. However, the elements of the base station are not limited to the above examples. For example, the base station may include more or fewer elements than the aforementioned elements. Furthermore, the controller 630, the transceiver 610, and the storage 620 may be implemented in the form of a single chip. The base station of FIG. 6 may correspond to the base station of the serving cell or the base station of the candidate cell of FIGS. 2 to 5. Further, the controller 630 of FIG. 6 may include at least one processor or controller.

The controller 630 may control a series of processes to enable the base station to operate according to an embodiment of the disclosure described above. For example, the controller may control elements of the base station to perform a method of scheduling a terminal depending on whether the base station mode is a base station energy saving mode or a base station normal mode, according to an embodiment of the disclosure. The controller 630 may be one or plural, and the controller 630 may execute a program stored in the storage 620 to perform the method of scheduling the terminal based on whether the base station mode is a base station energy saving mode or a base station normal mode according to an embodiment of the disclosure described above.

The transceiver 610 may transmit and receive signals to and from a terminal. The signals transmitted to and received from the terminal may include control information and data. The transceiver 610 may include a radio frequency (RF) transmitter that up-converts and amplifies a frequency of a signal being transmitted, and an RF receiver that low-noise amplifies and down-converts a frequency of a signal being received. However, this is only an embodiment of the transceiver 610, and the elements of the transceiver 610 are not limited to the RF transmitter and the RF receiver. Further, the transceiver 610 may receive signals via a wireless channel, output the signals to the controller 630, and transmit the signals output from the controller 630 via a wireless channel.

According to an embodiment of the disclosure, the storage 620 may store programs and data required for operation of the base station. In addition, the storage 620 may store control information or data included in the signals transmitted and received by the base station. The storage 620 may include a storage medium, such as read only memory (ROM), random access memory (RAM), hard disk, compact disc read only memory (CD-ROM), and a digital versatile disc (DVD), or combination of storage media. Additionally, the storage 620 may be plural. According to an embodiment of the disclosure, the storage 620 may store a program for performing a method of scheduling a terminal based on whether the base station mode is a base station energy saving mode or a base station normal mode, which are embodiments of the disclosure described above.

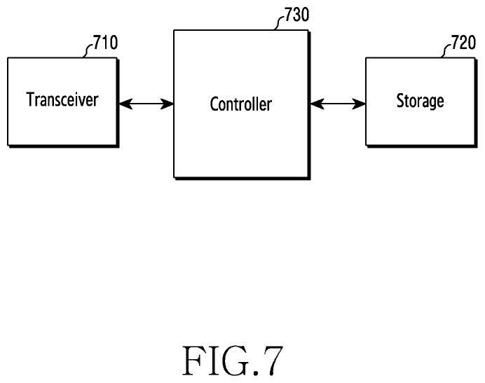

FIG. 7 is a block diagram illustrating a configuration of a UE according to an embodiment of the disclosure.

Referring to FIG. 7, a UE of the disclosure may include a controller (a control unit) 730, a transceiver 710, and storage (memory) 720. However, the elements of the UE are not limited to the above examples. For example, the UE may include more or fewer elements than the aforementioned elements. Furthermore, the controller 730, the transceiver 710, and the storage 720 may be implemented in the form of a single chip. According to an embodiment of the disclosure, the UE of FIG. 7 may correspond to the UE of FIGS. 2 to 5. Further, the controller 730 of FIG. 7 may include at least one processor or controller.

According to an embodiment of the disclosure, the controller 730 may control a series of processes to enable the UE to operate in accordance with the embodiments of the disclosure described above. For example, the controller 730 may control elements of the UE to perform a method for transmission and reception of the UE depending on whether the base station mode is a base station energy saving mode or a base station normal mode, according to embodiments of the disclosure. The controller 730 may be one or plural, and the controller 730 may execute a program stored in the storage 720 to perform transmission and reception operations of the UE in a wireless communication system applying carrier aggregation of the disclosure described above.

The transceiver 710 may transmit and receive signals to and from a base station. The signals transmitted to and received from the base station may include control information and data. The transceiver 710 may include an RF transmitter that up-converts and amplifies a frequency of a signal being transmitted, and an RF receiver that low-noise amplifies and down-converts a frequency of a signal being received. However, this is only an embodiment of the transceiver 710, and the elements of the transceiver 710 are not limited to the RF transmitter and the RF receiver. Further, the transceiver 710 may receive signals via a wireless channel, output the signals to the controller 730, and transmit the signals output from the controller 730 via a wireless channel.

According to an embodiment of the disclosure, the storage 720 may store programs and data required for operation of the UE. In addition, the storage 720 may store control information or data included in signals transmitted or received by the UE. The storage 720 may include a storage medium, such as a ROM, a RAM, a hard disk, a CD-ROM, or a DVD, or a combination of storage media. In addition, the storage 720 may be plural. According to an embodiment of the disclosure, the storage 720 may store programs for performing transmission and reception operations of the UE depending on whether the base station mode is a base station energy saving mode or a base station normal mode, which are embodiments of the disclosure described above.

The methods according to the claims of the disclosure described above or the embodiments described in the specification may be implemented in the form of hardware, software, or a combination of hardware and software.

When implemented as software, a computer-readable storage medium storing one or more programs (software modules) may be provided. The one or more programs stored on the computer-readable storage medium are configured for execution by one or more processors in the electronic device. The one or more programs include instructions that cause the electronic device to perform methods according to the claims of the disclosure or embodiments described herein.

Such programs (software modules, software) may be stored in random access memory, non-volatile memory, including flash memory, read only memory (ROM), electrically erasable programmable ROM (EEPROM), and electrically erasable programmable memory (electrically erasable programmable read only memory, EEPROM), magnetic disk storage device, compact disc ROM (CD-ROM), digital versatile discs (DVDs) or other forms of optical storage, magnetic cassette, or any combination of any or all of these. Alternatively, it may be stored in memory comprising a combination of any or all of these. Further, there may be a plurality of each of these configurable memories.

Further, the program may be stored on an attachable storage device that is accessible via a communication network, such as a communication network comprising the Internet, an intranet, a local area network (LAN), a wide area network (WLAN), or a storage area network (SAN), or any combination thereof. Such a storage device may be accessible to a device practicing embodiments of the disclosure via an external port. Additionally, a separate storage device on a communication network may be accessible to the device performing the embodiments of the disclosure.

In the specific embodiments of the disclosure described above, the components included in the disclosure have been expressed in the singular or plural, depending on the specific embodiment presented. However, the singular or plural expression has been chosen for ease of description and to suit the context presented, and the disclosure is not limited to the singular or plural components, and components expressed in the plural may be comprised in the singular, or components expressed in the singular may be comprised in the plural.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
receiving, on a serving cell, information on a measurement for a pathloss associated with a physical random access channel (PRACH) transmission for non-serving cell;
identifying a way of the measurement for the pathloss associated with the PRACH transmission, based on an indication of a cell specific measurement or a transmission configuration indication (TCI) specific measurement; or
identifying the way of the measurement for the pathloss associated with the PRACH transmission, based on an indication of a layer 1 (L1) measurement or a layer 3 (L3) measurement;
performing the measurement for the pathloss for a reference signal based on the identified way; and
transmitting, on a candidate cell, the PRACH transmission based on the pathloss.

2. The method of claim 1, wherein the L1 measurement is performed for the measurement for the pathloss, in case that the L1 measurement is indicated.

3. The method of claim 1, wherein the L3 measurement is performed for the measurement for the pathloss, in case that the L3 measurement is indicated.

4. The method of claim 1, wherein the pathloss is identified for a synchronization signal block (SSB) associated with the PRACH.

5. The method of claim 1, wherein the reference signal includes an SSB or a channel state information reference signal (CSI-RS).

6. A method performed by a base station in a wireless communication system, the method comprising:
transmitting, to a terminal on a serving cell, information on a measurement for a pathloss associated with a physical random access channel (PRACH) transmission for a non-serving cell; and
receiving, from the terminal, the PRACH transmission,
wherein the PRACH transmission is based on the measurement for the pathloss for a reference signal,
wherein a way of the measurement is indicated as a cell specific measurement or a transmission configuration indication (TCI) specific measurement, and
wherein the way of the measurement is indicated as a layer 1 (L1) measurement or a layer 3 (L3) measurement.

7. The method of claim 6, wherein the pathloss is based on the L1 measurement, in case that the L1 measurement is indicated.

8. The method of claim 6, wherein the pathloss is based on the L3 measurement, in case that the L3 measurement is indicated.

9. The method of claim 6, wherein the pathloss is based on a synchronization signal block (SSB) associated with the PRACH.

10. The method of claim 6, wherein the reference signal includes an SSB or a channel state information reference signal (CSI-RS).

11. A terminal in a wireless communication system, the terminal comprising:
a transceiver; and
a controller coupled with the transceiver and configured to:
receive, on a serving cell, information on a measurement for a pathloss associated with a physical random access channel (PRACH) transmission for non-serving cell,
identify a way of the measurement for the pathloss associated with the PRACH transmission, based on an indication of a cell specific measurement or a transmission configuration indication (TCI) specific measurement, or
identify the way of the measurement for the pathloss associated with the PRACH transmission, based on an indication of a layer 1 (L1) measurement or a layer 3 (L3) measurement,
perform the measurement for the pathloss for a reference signal based on the identified way, and
transmit, on a candidate cell, the PRACH transmission based on the pathloss.

12. The terminal of claim 11, wherein the L1 measurement is performed for the measurement for the pathloss, in case that the L1 measurement is indicated.

13. The terminal of claim 11, wherein the L3 measurement is performed for the measurement for the pathloss, in case that the L3 measurement is indicated.

14. The terminal of claim 11, wherein the pathloss is identified for a synchronization signal block (SSB) associated with the PRACH.

15. The terminal of claim 11, wherein the reference signal includes an SSB or a channel state information reference signal (CSI-RS).

16. A base station in a wireless communication system, the base station comprising:
a transceiver; and
a controller coupled with the transceiver and configured to:
transmit, to a terminal on a serving cell, information on a measurement for a pathloss associated with a physical random access channel (PRACH) transmission for a non-serving cell, and
receive, from the terminal, the PRACH transmission,
wherein the PRACH transmission is based on the measurement for the pathloss for a reference signal,
wherein a way of the measurement is indicated as a cell specific measurement or a transmission configuration indication (TCI) specific measurement, and
wherein the way of the measurement is indicated as a layer 1 (L1) measurement or a layer 3 (L3) measurement.

17. The base station of claim 16, wherein the pathloss is based on the L1 measurement, in case that the L1 measurement is indicated.

18. The base station of claim 16, wherein the pathloss is based on the L3 measurement, in case that the L3 measurement is indicated.

19. The base station of claim 16, wherein the pathloss is based on a synchronization signal block (SSB) associated with the PRACH.

20. The base station of claim 16, wherein the reference signal includes an SSB or a channel state information reference signal (CSI-RS).
